(19) United States
(12) Patent Application Publication
(10) Pub. No.: US 2012/0037857 A1
(43) Pub. Date: Feb. 16, 2012

(54) Method for Manufacturing a Powder for the Production of P-Type Transparent Conductive Films

(76) Inventors: Guido Huyberechts, Steenokkerzeel (BE); Griet Drees, Mol (BE); Daan Goedeme, Herentals (BE)

(21) Appl. No.: 13/133,172

(22) PCT Filed: Nov. 30, 2009
(86) PCT No.: PCT/EP2009/008509

§ 371 Date: Oct. 20, 2011

Related U.S. Application Data
(60) Provisional application No. 61/193,711, filed on Dec. 18, 2008.

(30) Foreign Application Priority Data
Dec. 8, 2008 (EP) 08021257.4

(51) Int. Cl. H01B 1/08

(52) U.S. Cl. 252/519.1

(57) ABSTRACT

This invention relates to material compositions, a manufacturing method for these materials and a manufacturing method for ceramic bodies, to be used as targets in physical vapour deposition techniques of p-type transparent conductive films. There is disclosed a method for manufacturing a pelletized oxide material Mₓ Sr₁₋ₓCu₂₋₊ₐO_{2+b}, wherein −0.2≦a≦0.2, −0.2≦b≦0.2, and M is either one or more of the group of bivalent elements consisting of Ba, Ra, Mg, Be, Mn, Zn, Pb, Fe, Cu, Co, Ni, Sn, Pd, Cd, Hg, Ca, Ti, V, Cr; with 0≦x≦0.2; comprising the steps of: —providing a precursor mixture having a given grain size distribution, and comprising stoichiometric quantities of Cu₂O, Sr(OH)₂.8H₂O, and, when 0≦x≦0.2, M-hydroxide, —intimately mixing said precursor mixture so as to obtain a homogeneous mixture, and —sintering said homogeneous mixture at a temperature above 850° C. The oxide material Sr Cu₂₊ₐO_{2+b} has a residual carbon content of less than 400 ppm, and a target having a density of at least 5.30 g/ml can be manufactured with it.

This invention relates to material compositions, a manufacturing method for these materials and a manufacturing method for ceramic bodies, to be used as targets in physical vapour deposition techniques of p-type transparent conductive films.

During the last decades, significant advancements have been made in the development of transparent conductive oxides. ITO, indium tin oxide, has the lowest resistivity obtained thus far for n-type transparent conductive oxides and combines a resistivity of ˜10⁻⁴ Ωcm with a transparency of up to 80-90% over the visible-NIR spectral range. Aluminium doped zinc oxide, ZnO:Al, has been suggested, and is used in a number of applications, as alternative to ITO but its performance is still somewhat inferior to that of ITO (resistivity >10⁻⁴ Ωcm). All the transparent conductive oxides showing resistivities in this order of magnitude however are n-type conductive oxides.

Hence, despite their excellent characteristics, their application is merely limited to applications where transparent conductive electrodes are required, such as light emitting devices, flat panel displays, photovoltaic devices, smart windows, etc. In order to allow the construction of novel type of electro-optic devices there is the need for p-type transparent conductive oxides as well. The availability of high quality p-type transparent conductive oxides would allow the combination of these materials with existing n-type materials into transparent active devices, by the formation of p-n junctions and allowing the manufacturing of transparent transistors. This allows the formation of UV light emitting diodes (resulting for example in novel display types if combined with phosphors, transparent electronic circuits, sensors, . . . ). This observation has been made by a number of researchers and inventors in the past and has resulted in a substantial amount of research towards the development of transparent conductive p-type materials.

However, the p-type transparent conductive oxides identified to date have resistivities that are at least one order of magnitude higher than their n-type counterparts and typically need high temperatures for the formation of thin films. Examples can be found in H. Kawazoe et al., P-type electrical conduction in transparent thin films of CuAlO₂, Nature, 389, 939-942 (1997); and H. Mizoguchi, et. al, Appl. Phys. Lett., 80, 1207-1209 (2002), H. Ohta, et al, Solid-State Electronics, 47, 2261-2267 (2003), both dealing with AMO₂ configuration materials, where A is the cation and M is the positive ion, for example CuAlO₂.

Despite the poor performance of these p-type transparent conductive oxides known to date, a number of studies on the formation of transparent p-n junctions has already been reported, such as transparent diodes based on p-n homojunctions (CuInO₂) in K. Tonooka, et al, Thin Solid Films, 445, 327, (2003); and opto-electronic devices utilising p-n heterojunctions (p-SrCu₂O₂/n-ZnO), in H. Hosono, et al, Vacuum, 66, 419 (2002). Other materials are p-ZnRh₂O₄/n-ZnO UV-LEDs, p-NiO/n-ZnO UV detectors, UV-detector based on pn-heterojunction diode composed of transparent oxide semiconductors, such as p-NiO/n-ZnO, and p-CuAlO₂/n-ZnO photovoltaic cells and transparent electronics.

However, the performance of these diodes was poor due to poor material quality, non-optimum resistivity and carrier concentration of the p-type transparent conductive oxides or not abrupt interfaces of the heterojunctions, thus, giving ideality factors not less than 1.5, forward current to reverse current ratios between 10 and 80 for V<□4V, breakdown voltage less than 8 Volts, increased series resistance and turn-on-voltage not corresponding always to the band gap of the materials. The transparency of these devices was between 40% and 80%.

Work by the groups of Kawazoe and Hosono (e.g. in H. Yanagi et al., J. Electroceram., 4, 407 (2000)) has led to the description of a number of p-type transparent conductive oxides based on Cu(I) bearing oxides. A UV-emitting diode based on p-n heterojunction composed of p-SrCu₂O₂ and n-ZnO was successfully fabricated by heteroepitaxial thin film growth, as reported in H. Ohta, et al., Electron. Lett., 36, 984 (2000). Among these p-TCO materials, SrCu₂O₂ (also referred to as SCO) is one of the most promising candidates for use in optoelectronic devices, mainly because the epitaxial films can be obtained at relatively low temperatures to prevent interface reactions in the junction region. Although synthesis of undoped and K-doped SrCu₂O₂ thin films has been reported, e.g. in U.S. Pat. No. 6,294,274 B1, the effects of dopant on the optoelectronic property of SrCu₂O₂ are not yet fully understood and the conduction of SrCu₂O₂ films has up to now been smaller than that of the other p-type TCOs.

A number of reports mentioned above is related to the deposition of thin films from solution. Other common techniques for the deposition of thin films are covered by the general name of physical vapour deposition, comprising, but not limited to, techniques such as diode and magnetron sputtering, reactive sputtering, vacuum evaporation, pulsed lased deposition (PLD), laser ablation, IAD, etc. These techniques mainly use solid ceramic or metallic bodies, the so-called targets. It is known in the art that ceramic bodies or targets used in such techniques preferably have a high density (low porosity) and homogeneity as well as preferably the absence of multiple compounds and phases to avoid preferential sputtering and concentration and composition inhomogeneities over deposition or production time for the resulting thin films.

Sheng et al reported in “Oriented growth of p-type transparent conducting Ca-doped SrCu₂O₂ thin films by pulsed laser deposition”, Semicond. Sci. Technol., 21, 586-590 (2006) on the pulsed laser deposition of a doped SCO film. The PLD target was made from a polycrystalline Ca-doped SrCu₂O₂ powder, synthesized by heating the mixture of Cu₂O, SrCO₃ and CaCO₃. Firstly, pure powder of Cu₂O (99.9%), SrCO₃ (99.9%) and CaCO₃ (99.99%) was taken at 10:9:1 atomic ratio and mixed thoroughly in a ball mill for 24 h. Then, the mixture was heated at 900° C. for 15 h in an argon atmosphere. The sintered body was reground and pressed into a pellet, and the pellet was sintered at 900° C. for 10 h in an argon atmosphere, which was used as the target for PLD. This method describes in general the state-of-the-art of making targets for PLD.

In U.S. Pat. No. 7,087,526 B1 a method of fabricating a p-type CaO doped SrCu₂O₂ thin film by spin-coating of an acetate precursor mixture is disclosed.

Up to now, the manufacturing of the transparent conductive films by using physical vapour deposition techniques has shown a number of technical problems, related to the nature of the ceramic bodies used. Today's commercially available materials are not dense enough, and are also not homogeneous. The problems are linked to the use of excessively high temperatures in the formation of the targets, and the existence of residual carbon contamination in the target. These problems will be illustrated in the Comparative Examples below.

The invention aims to describe an improved method for the manufacturing of a p-type transparent conductive oxide containing strontium, copper and oxygen, and making of bodies thereof for physical vapour deposition, that does not have the problems cited before.

According to the invention, a method for manufacturing a pelletized oxide material Mₓ Sr₁₋ₓCu₂₊ₐO_{2+b} is disclosed, wherein −0.2≦a≦0.2, −0.2≦b≦0.2, and M is either one or more of the group of bivalent elements consisting of Ba, Ra, Mg, Be, Mn, Zn, Pb, Fe, Cu, Co, Ni, Sn, Pd, Cd, Hg, Ca, Ti, V, Cr; with 0≦x≦0.2; comprises the steps of:
providing a precursor mixture having a given grain size distribution, and comprising stoichiometric quantities of Cu₂O, Sr(OH)₂.8H₂O, and, when 0<x≦0.2, M-hydroxide,
intimately mixing said precursor mixture so as to obtain a homogeneous mixture, and
sintering said homogeneous mixture at a temperature above 850° C.

During the step of intimately mixing said precursor mixture, it is preferable to preserve the grain size distribution, and between the step of intimately mixing the precursor mixture and sintering the homogeneous mixture, the homogeneous mixture should preferably undergo a calcination step at a temperature between 60° and 100° C.

The step of inimatety mixing is preferably performed in a Turbula mixer, and the calcination step is preferably a vacuum drying step.

In one embodiment, the method above further comprises the step of preparing a target by submitting the pelletized oxide material to a thermal compaction cycle at a temperature above 950° C. and a pressure of at least 2.5 kN/cm², and preferably at least 3.5 kN/cm². The thermal compaction cycle is preferably performed at a temperature between 975 and 1025° C.

In a preferred embodiment, x=1±0.2, M=Ba, and M-hydroxide is Ba(OH)₂.8H₂O.

The invention also covers a powderous oxide material Sr Cu₂₊ₐO_{2+b}, wherein −0.2≦a≦0.2, −0.2≦b≦0.2, with a residual carbon content of less than 400 ppm. This powderous oxide material is used for the manufacturing of a target, where the targets have a density of at least 5.30 g/ml, and are obtained by a process comprising the steps of
sintering said homogeneous mixture at a temperature above 850° C., thereby obtaining a pelletized oxide material, and
submitting said pelletized oxide material to a thermal compaction cycle at a temperature above 950° C. and a pressure of at least 2.5 kN/cm², and preferably at least 3.5 kN/cm².

Preferably the target has a density of at least 5.40, or even 5.45 g/ml. In a preferred embodiment the target is used for PVD deposition, such as magnetron sputtering, of p-type transparent conductive films.

It will be shown that, where the temperature and time of the manufacturing process has been reduced as compared to prior work, it was unexpectedly also observed that purity of the powder and homogeneity of the ceramic bodies resulting from powder manufactured with the improved method were substantially improved.

The invention is illustrated by the following Figures:

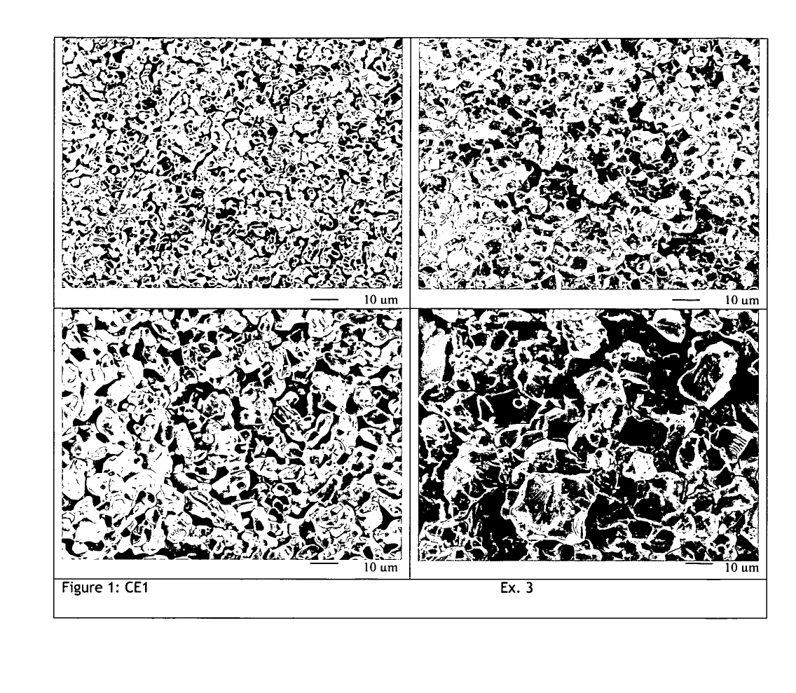

FIG. 1: Comparison of SEM images of freshly created cross sections of targets

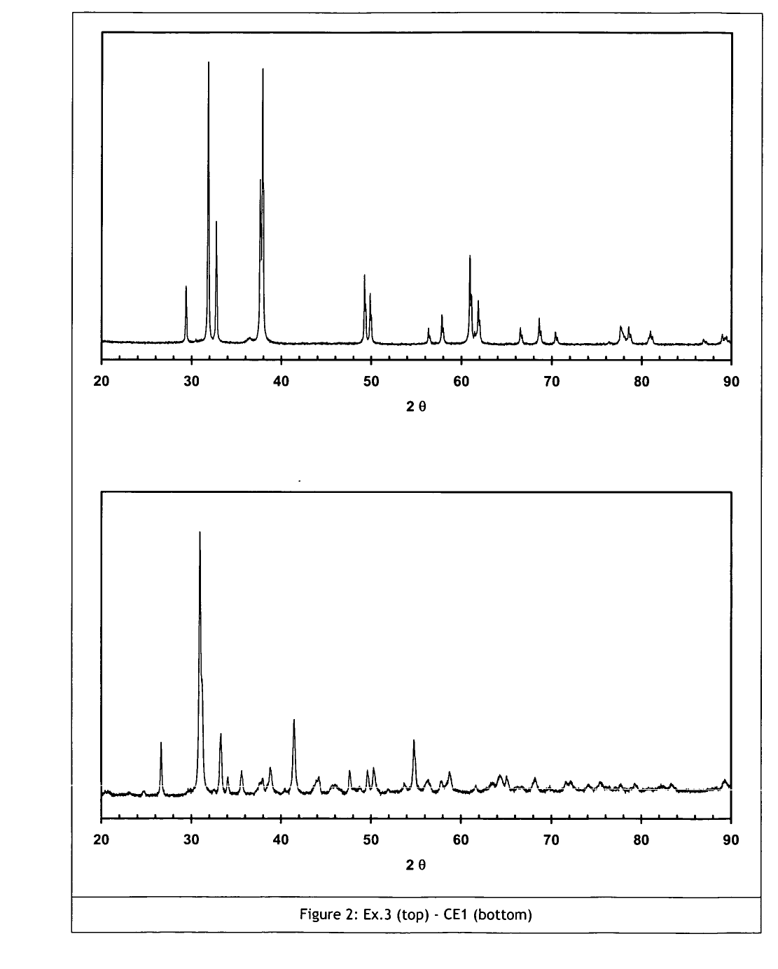

FIG. 2: Comparison of X-ray diffraction patterns of prior art vs. invented products

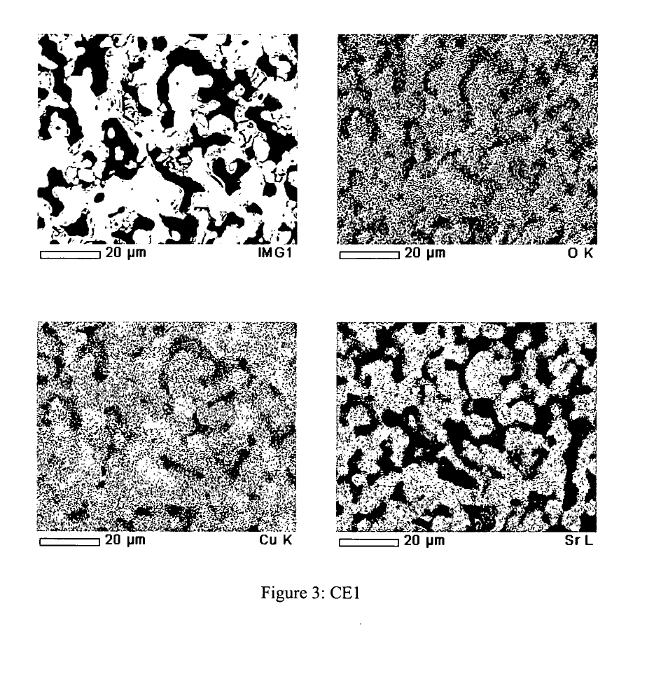

FIG. 3a & b: EDS line analysis and mapping of prior art vs. invented products

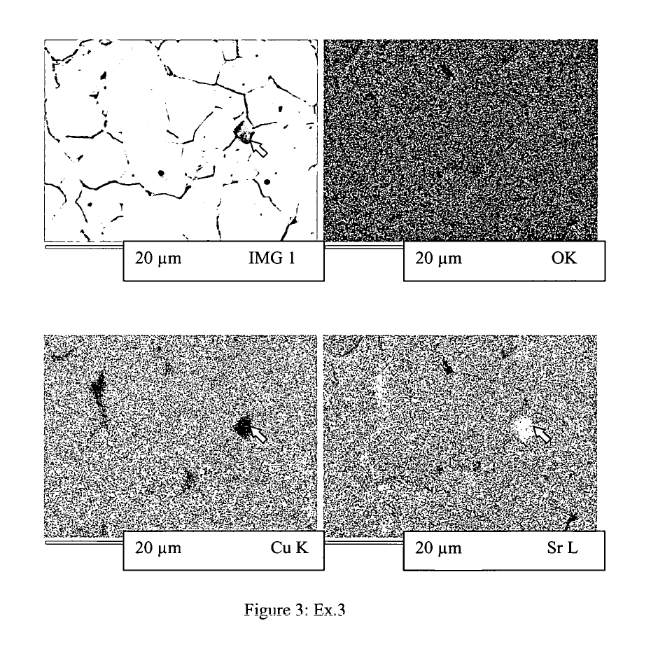

FIG. 4: XRD evolution throughout synthesis for the Suzuki-Gauckler method

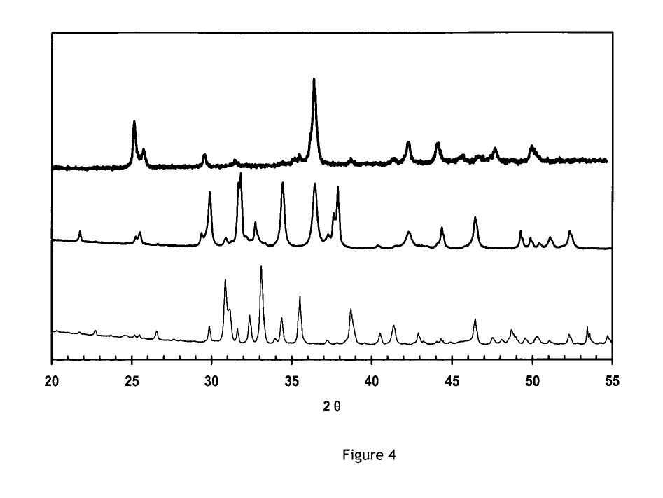

FIG. 5: Powder diffractogram of calcined powder of the Martinson-Ginley method

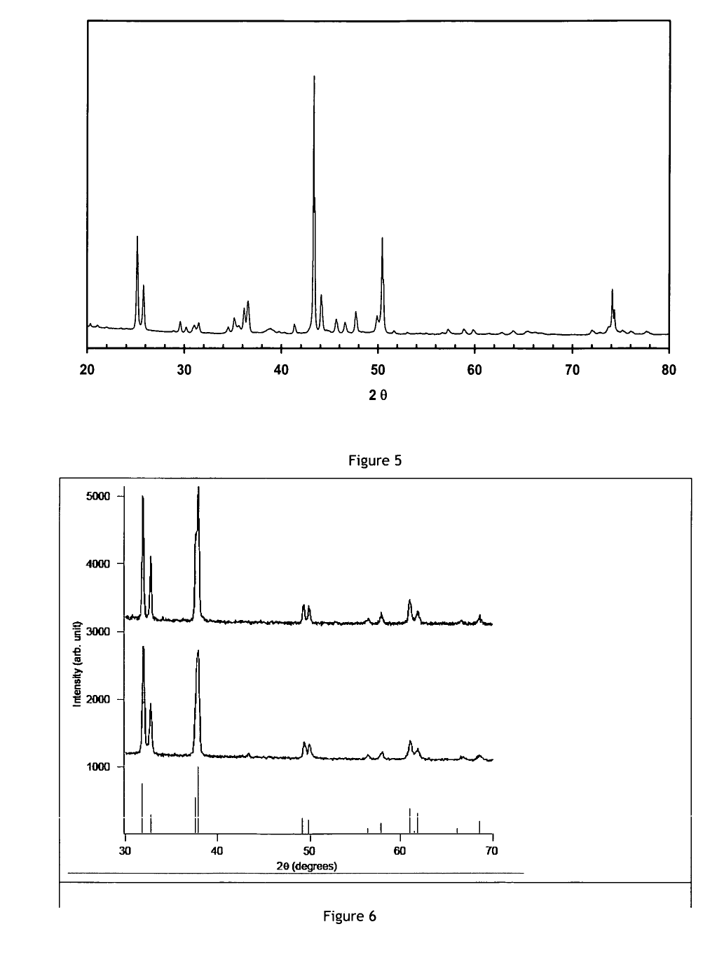

FIG. 6: XRD θ/2θ spectra of bulk phase SrCu₂O₂, Ca substituted SrCu₂O₂, and expected powder pattern intensities

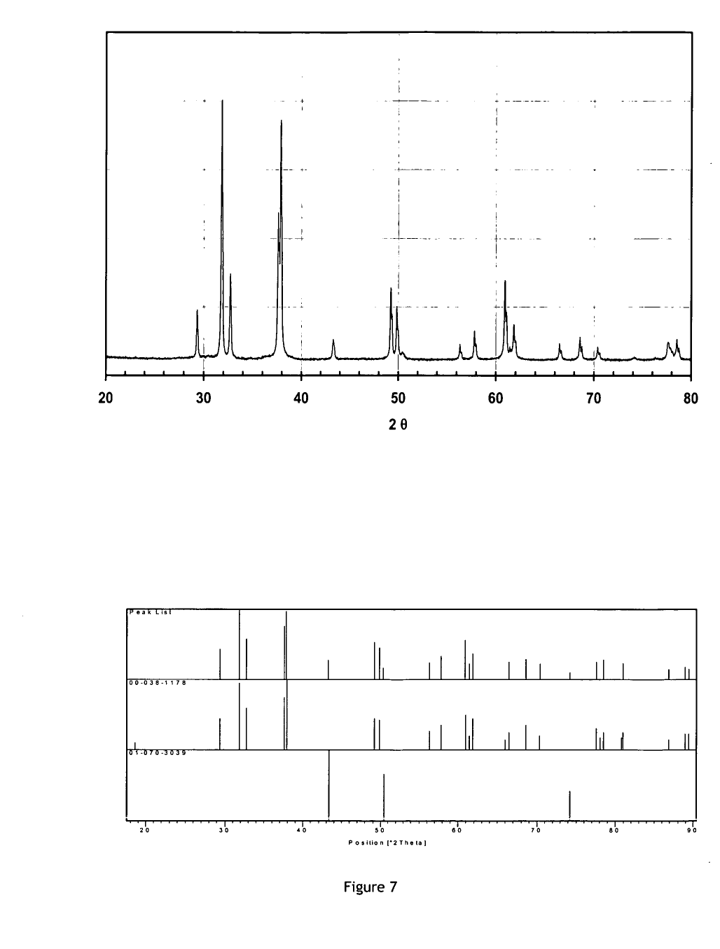

FIG. 7: Powder diffractogram of calcined powder of the Kudo method, its peak list, and the peak lists of SrCu₂O₂ and Cu.

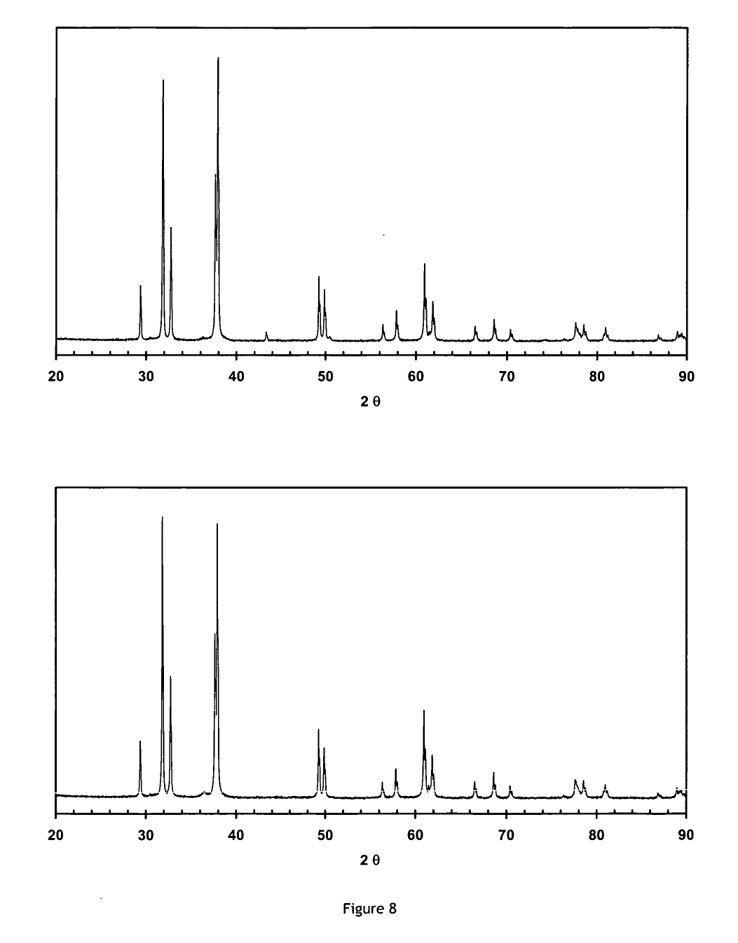

FIG. 8: Comparison of X-ray diffraction patterns of the products of the Kudo and the Carbonate lean method

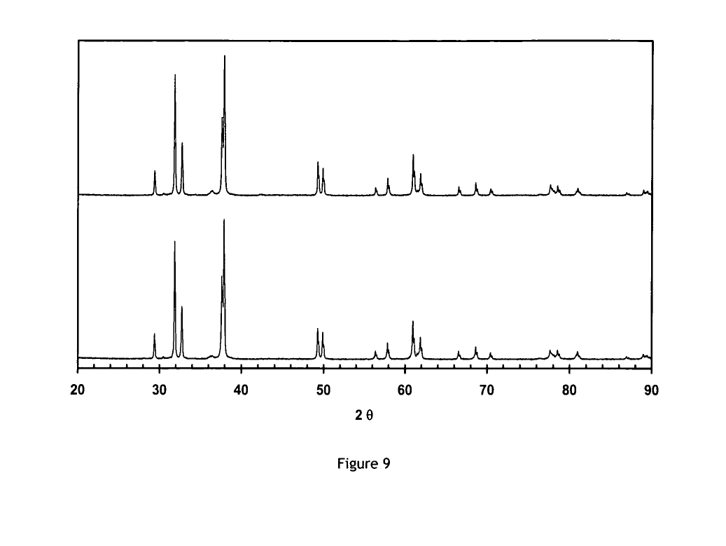

FIG. 9: Comparison of X-ray diffraction patterns for different carbonate lean methods

The invention is further illustrated by the following (Counter-)Examples.

### COUNTEREXAMPLE 1

### State of the Art Product (CE1)

Targets for making thin strontium copper oxide films (SCO) by pulsed laser deposition (PLD) are commercially available from STMC (Sputtering Target Manufacturing Company, Westerville, Ohio, USA). Analysis of these targets using the Archimedes' principle show a density of (3.90±0.10) g/ml (s.d.; n=3). On SEM pictures of a cross section of a freshly broken surface, as shown in FIG. 1—left part (CE1), it can be seen that the material is highly porous, which leads to a relatively low target density.

By X-ray diffraction pattern investigations, as shown in FIG. 2—lower part (CE1), it can be determined that the targets consist mainly of a copper strontium oxide Cu₃Sr_{1.75}O_{5.13} [00-039-0489] and copper oxide CuO [01-080-1268], with traces of carbon and only traces of the target compound Cu₂SrO₂ [00-038-1178]. (The numbers between brackets refer to the collection of the JCPDS-International Centre for Diffraction Data®.)

Further analysis by X-ray compositional micro analysis (Energy Dispersive Spectrometer) in line scan and mapping mode is carried out on polished cross sections. This analysis confirms, as becomes clear in FIG. 3 (CE1), the porosity of the target sample as well as the very inhomogeneous nature of the material. Due to the overall difficulty of finding appropriate targets on the market, a number of target manufacturing processes described in literature were tested.

### COUNTEREXAMPLE 2

### Manufacturing Processes Described in Literature

### a) the Suzuki-Gauckler Method

A manufacturing process described in Suzuki, Ryosuke O.; Bohac, Petr; Gauckler, Ludwig J., Thermodynamics and phase equilibria in the strontium-copper-oxygen system, Journal of the American Ceramic Society (1992), 75(10), 2833-42; uses a classical ceramic route for making multimetal oxides (“mix-shake and bake”). The starting materials for this procedure are CuO and SrCO₃ (resp. 380.0 g and 357.0 g), sieved to 200 mesh. The starting material therefore consists of a mixture of powders smaller than 75 □m and is further homogenized by Turbula mixing.

The following procedure is then followed:

### Step 1: Calcination in air at 950° C. for 200 h

Step 2: Milling the calcined powder in ring mill until all powders passes a 200 mesh screen (<75 μm)
Step 3: Cold compaction of powder into pellets
Step 4: Sintering of pellets in argon at 900° C. for 16 h
Step 5: Milling the sintered pellets in ring mill until all powders passes a 200 mesh screen (<75 μm) (analysis)
Step 6: Cold compaction of powders into pellets
Step 7: Sintering of pellets in argon at 900° C. for 18 h
Step 8: Milling the sintered pellets in ring mill until all powders passes a 200 mesh screen (<75 μm) (analysis)
Step 9: Cold compaction of powders into pellets
Step 10: Sintering of pellets in argon at 900° C. for 17 h
Step 11: Milling the sintered pellets in ring mill until all powders passes a 200 mesh screen (<75 μm) (analysis)
Step 12: Cold compaction of powders into pellets
Step 13: Sintering of pellets in argon at 900° C. for 66 h
Step 14: Sintering of pellets in nitrogen (100 l/h) at 775° C. for 4 h

The resulting pellets show densities (Archimedes' method) from 4.59 to 5.00 g/ml. After the first calcination (Step 1), after Step 11 and at the end of the process (Step 14) powder samples were submitted for X-ray diffraction analysis. The results in FIG. 4 (bottom line: after Step 1, middle line: after Step 11, top line: at end of process) show that substantial changes occur during the process of this method. (The peaks of each sample are normalized to the highest peak and shifted arbitrarily on the y-axis). But is also clear that even after a total process time of more than 300 h (or nearly two weeks) this method does not yield the desired product. The final diffractogram indicates the presence of a majority SrCuO₂ phase, with contributions from the target compound SrCu₂O₂ and to a lesser extent also from Cu₂O, CuO and Sr₁₄Cu₂₄O₄₁.

### b) the Modified Martinson-Gintey Method

This method uses a direct deposition of thin films from aqueous precursors, see A. Martinson, Synthesis of single phase SrCu2O2 from liquid precursors, DOE Energy Research Undergraduate Laboratory Fellowship Report, National Renewable energy Laboratory, Golden, Co (2002). As this method was developed for direct deposition of thin films of the target compound, it was modified in order to obtain powders for further processing and transformation into solid bodies that can be used as targets for physical vapour deposition.

The original procedure starts from solutions of copper formiate (Cu(CH₂OO)₂.4H₂O) and strontium acetate (Sr(CH₃COO)₂) with a Cu:Sr-ratio of exactly 2:1. This solution is applied to a substrate by an airbrush technique. The substrate is heated to 180° C. The substrate with the deposited film is then annealed for 4 h at 775° C. in 2.0 10⁻⁵ Torr oxygen atmosphere. At the end of the annealing period the substrate is cooled to room temperature (at 650° C. the oxygen flow is stopped).

In the modified method, the raw materials for making the powder are the same as in the Martinson-Ginley route, but the procedure is modified as follows:
The solution is spray dried at 180° C.
Annealing takes 4 h at 775° C. in nitrogen
Cool down to room temperature in nitrogen

Copper formiate (tetra aqua)(Aldrich, 97%) and strontium acetate (Aldrich), resp. 1140.0 g and 500.1 g, are dissolved in 3.92 l of demineralised water. This solution is spray dried in a Niro lab scale spray dryer (S80), equipped with an atomizer (SL 24-50/M-02/B with straight channels [493-1889-019]).

The spray dried powder is heated to 775° C. in a tube furnace and kept under nitrogen atmosphere at 775° C. for 4 h. The quartz crucibles are filled about ¾ with the precursor powder. During the calcination an appreciable volume expansion is observed.

It is clear from the XRD diagram in FIG. 5, that the material after calcination is not phase pure and is a mixture of products, when compared to FIG. 6, representing the XRD spectra of pure SrCu₂O₂ (top), Ca substituted SrCu₂O₂ (middle), and the expected powder pattern intensities (bottom) (taken from JCPDS 38-1178—International Centre for Diffraction Data®).

From a manufacturing point of view the sequence of making a homogeneous solution, spray drying and calcination of the resulting powder can often be replaced by a direct spray combustion or spray pyrolysis technique. This method starts from the same precursor solution as above, except that instead of a spray drying step at 180° C. a spray combustion at 580° C. is used. The resulting powder is further annealed at 775° C. as under b).

It was observed that the major phases formed under these conditions are strontianite

(SrCO₃), Tenorite (CuO), Copper(I) oxide (Cu₂O) and copper. An unexplained loss of copper is also observed.

It has to be concluded that this method does not yield the right composition. It shows that in materials starting from carbon containing strontianite, the latter is showing up as an end product. This strontium carbonate is a very stable compound with a decomposition temperature of 1075° C. In oxidizing atmospheres a lower decomposition temperature of around 800° C. may be observed, whilst in CO₂ atmospheres a decomposition at around 1220° C. is reported. Since for the manufacturing of the target compound a non-oxidising environment is required (in order to avoid oxidation of Cu(I) to the Cu(II) state, the decomposition temperature of any carbonate formed will be above 1050° C.

c) the Kudo Method

The observation from the previous method on the stability of strontium carbonate can be evaluated by using a method inspired by the work of Kudo, in Kudo, A.; Yanagi, H.; Hosono, H.; Kawazoe, H, A new p-type conductive oxide with wide band gap, SrCu202, Materials Research Society Symposium Proceedings (1998), 526 (Advances in Laser Ablation of Materials), 299-304 and Kudo, Atsushi; Yanagi, Hiroshi; Ueda, Kazushige; Hosono, Hideo; Kawazoe, Hiroshi; Yano, Yoshihiko, Fabrication of transparent p-n heterojunction thin-film diodes based entirely on oxide semiconductors, Applied Physics Letters (1999), 75(18), 2851-2853.

As starting material this method uses Cu₂O and SrCO₃, which are mixed in stoechiometric 2:1 Cu:Sr ratio. The raw materials are intimately mixed and milled in a Retsch ZM100 mill, with a 120 □m screen installed. The mixture is placed during 40 h in a nitrogen flow (240 l/h) at 950° C. After cooling the sintered body under nitrogen, the product is reground and pressed into a pellet by cold isostatic pressing at 800 kg/cm². The resulting pellets are sintered for 10 h at 850° C. under nitrogen.

Chemical analyses of the powder shows that (in terms of mass percentage) the resulting product contains (35.23±0.07) mass % Sr and (51.19±0.06) mass % Cu. The residual carbon contamination amounts to 0.043-0.059 mass % C.

X-ray powder diffraction learns that in this method we obtain the correct material phase with a minor impurity of metallic copper, as shown in FIG. 7, giving the powder diffractogram of calcined powder, its peak list (bottom figure, top line), and the peak lists of SrCu₂O₂ [00-038-1178] (bottom figure, middle line), and Cu [01-070-3039] (bottom figure, bottom line).

The powder is cold compacted and pressure-less sintered, but turns out to be very brittle without major improvement in density. The resulting pellets break during polishing. As a consequence the compaction method is changed to hot pressing. The following thermal cycle is used for compaction of the powder obtained according to this method (30 mm graphite dies, boron nitride coated).
1. Cold compaction at 20 kN
2. Heating at minimal load (4 kN) at 50° C./min
3. Load increase from 4 to 10 kN at 900° C.
4. Load increase from 10 to 20 kN at 975° C.
5. Dwell at 975° C. for 30 min
6. Cool down by natural convection

The density of the obtained targets is 5.33±0.10 g/ml.

### EXAMPLE 3

### Example According to the ‘Carbonate Lean’ Method of the Invention

Although the carbon contamination of the end product from the Kudo method above is relatively low considering the use of a carbonate as starting material, and the temperatures used are on the low side for complete thermal decomposition, an attempt was made to further reduce the amount of carbon based impurities in the material. Therefore a method is developed similar to the Kudo method, but with Sr(OH)₂.8H₂O as reactant. This method is referred to as the ‘Carbonate lean’ method. In industry (e.g. Solvay SA) Sr(OH)₂.8H₂O is known to be the most common form of Sr-hydroxide. A run of both Kudo and the carbonate lean methods are carried out in parallel in order to prepare and analyse the samples under identical conditions.

In FIG. 8 the X-ray diffraction patterns are summarized for both methods (Kudo method: top, Carbonate lean method: bottom). Both materials are identified as SrCu₂O₂ (with apparently some trace impurities present (e.g. copper in the case of Kudo).

The carbon content of the end products is 0.072% and 0.034% for resp. Kudo and the Carbonate lean method. The presence of carbon contamination in the product according to the invention could indicate absorption of carbon dioxide from atmosphere by the strontium hydroxide raw material, instead of originating from the carbonate precursor used.

Sufficient material is made to explore the compaction process for conditions yielding a higher density, which is considered advantageous in the development of targets. The compaction process of method 2-c is used in an adapted way where control parameters such as temperature, pressure and hold time is varied, yielding the results of the following Table.

TABLE 1
Compaction results

| Temperature | Pressure | Time | ρ |
|---|---|---|---|
| (° C.) | (kN) | (min) | (g/ml) |
| 975 | 20 | 30 | 5.439 |
| 975 | 20 | 45 | 5.345 |
| 975 | 25 | 30 | 5.411 |
| 1025 | 20 | 30 | 5.414 |
| 1025 | 25 | 30 | 5.472 |
| 1025 | 20 | 45 | 5.425 |
| 975 | 25 | 45 | 5.446 |
| 1025 | 25 | 45 | 5.458 |

(ρ: density)
Note that the pressure is expressed as a force exercised on a target with 3 cm diameter (surface: 7.07 cm²), 20 kN corresponding to 2.83 kN/cm², 25 kN to 3.54 kN/cm².

As a conclusion it can be stated that higher densities are obtainable, with increased pressure and temperature having a positive effect on density, and increased hold time a small negative effect. Care should however be taken not to increase temperature and holding time too much in order to avoid decomposition.

Compared to the target in Counterexample 1, the targets according to the invention appear to be far more phase pure, with indeed the target compound present and only traces of other impurities related to the starting products. This is shown on FIG. 2: upper part: material according to the invention (Carbonate lean), lower part: material of Counterexample 1.

On SEM pictures of a cross section of a freshly broken surface, as shown in FIG. 1—right part (Ex. 3), it can be seen that the material is much less porous than the material of Counterexample 1. Comparing the analysis by X-ray compositional micro analysis (Energy Dispersive Spectrometer) of the elements oxygen (top right), copper (bottom left) and strontium (bottom right), see FIG. 3 (Ex. 3 against CE1), it is noted that the compositional homogeneity of the target of the invention is far more even and hence in the sputtered films less compositional variation (Sr/Cu-ratio) with abalation/erosion depth is expected (under the assumption of absence of preferential ablation/erosion or sputtering).

As it can be observed during the milling step of the raw materials in the Retsch ZM100, due to the use of Sr(OH)₂.8H₂O, that the release of crystal water turns the powder mixture into a viscous paste, the Retsch ZM100 centrifugal mill step is preferably replaced by thorough mechanical mixing in a Turbula mixer for 1 h, followed by a vacuum drying at 80° C. Note that both materials show an identical and desired X-ray diffraction diagram (see FIG. 9: top: using the Retsch mill; bottom: using the Turbula mixer), with some more pronounced traces of Cu₂O in the powder obtained with the original procedure. It can be concluded that both materials are identical and suited for target manufacturing, despite the mechanical problems inherent to the method using milling of Sr(OH)₂.8H₂O.

The obtained green powder is tested under hot pressing conditions. The use of the appropriate mixing and vacuum drying step avoids the formation of a paste, and after a hot pressing step of 40 h under nitrogen at 950° C., and a secondary milling in the Retsch ZM100 mill (and screening over 80 □m) a mass decrease of 19.6% was observed, against 33.3% in the original procedure (with the ‘primary’ Retsch centrifugal milling step). The press cycle results in a colour change form black into grey.

For the ‘original procedure’ powder the color change indicates that an oxidation or modification had taken place. Analysis of the remaining materials learns that in the calcined materials small amounts of the initial products (i.c. strontium hydroxide) can be found, most likely inducing further unintentional reactions during the hot press cycle.

If, after Turbula mixing, the vacuum drying step is omitted before the hot press cycles, it turns out that after the compaction and cooling down, all targets disintegrate into powder. This is not the case for the targets formed with the carbonate lean method with either milling (Retsch) or milling (Turbula) and vacuum drying. The preferred method for upscaling the production should avoid the formation of a paste inside the mill, even if this is at the expense of an additional mixing/drying step.

### EXAMPLE 4

### Preparation of a Target Ba Sr Cu₂O₂

Analogous with Example 3, the target manufacturing process can be summarized as follows:

Weigh Cu₂O, Sr(OH)₂.8H₂O and Ba(OH)₂.8H₂O=>

Mix ingredients using a Turbula mixer=>

Dry ingredients under vacuum at 80-90° C. for 4 days=>

Mix and mill in a Retsch ZM100 centrifugal mill to 80 μm=>

React in furnace under nitrogen at 950° C. during 40 h=>

Mix and mill in a Retsch ZM100 centrifugal mill to 250 μm=>

Mix and mill in a Retsch ZM100 centrifugal mill to 80 μm=>

Package and seal=>

Apply compaction, cold pressing=>

Heat up to and hold at 975° C.=>

Cool down=>

Grind and polish.

1-11. (canceled)

12. A method for manufacturing a pelletized oxide material Mₓ Sr₁₋ₓCu₂₊ₐO_{2+b}, wherein −0.2≦a≦0.2, −0.2≦b≦0.2, and M is one or more of the group of bivalent elements selected from the group consisting of Ba, Ra, Mg, Be, Mn, Zn, Pb, Fe, Cu, Co, Ni, Sn, Pd, Cd, Hg, Ca, Ti, V, and Cr; with 0≦x≦0.2; comprising
providing a precursor mixture having a given grain size distribution, and comprising stoichiometric quantities of Cu₂O, Sr(OH)₂.8H₂O, and M-hydroxide,
intimately mixing said precursor mixture so as to obtain a homogeneous mixture, and
sintering said homogeneous mixture at a temperature above 850° C.

13. The method of claim 12, wherein during said intimately mixing said precursor mixture, said given grain size distribution is preserved, and further comprising calcinating said homogeneous mixture between intimately mixing said precursor mixture and sintering said homogeneous mixture, at a temperature between 60° and 100° C.

14. The method of claim 13, wherein intimately mixing is performed in a Turbula mixer.

15. The method of claim 13, wherein calcinating comprises vacuum drying.

16. The method of claim 12, further comprising preparing a target by submitting said pelletized oxide material to a thermal compaction cycle at a temperature above 950° C. and a pressure of at least 2.5 kN/cm².

17. The method of claim 16, wherein the pressure is at least 3.5 kN/cm².

18. The method of claim 16, wherein said thermal compaction cycle is performed at a temperature between 975 and 1025° C.

19. The method of claim 12, wherein M=Ba and M-hydroxide is Ba(OH)₂.8H₂O.

20. A powderous oxide material SrCu₂₊ₐO_{2+b}, wherein −0.2≦a≦0.2, −0.2≦b≦0.2, comprising a residual carbon content of less than 400 ppm, and obtainable by the method of claim 12.

21. A method of manufacturing a target having a density of at least 5.30 g/ml, employing the powderous oxide material of claim 20.

22. The method of claim 21, wherein said target has a density of at least 5.40 g/ml.

23. The method of claim 22, wherein said target has a density of at least 5.45 g/ml.
